(19) United States
(12) Patent Application Publication
(10) Pub. No.: US 2017/0165812 A1
(43) Pub. Date: Jun. 15, 2017

(54) Clamping tool attachment for use with a polished rod

(71) Applicant: Scott Finnestad, Red Deer (CA)

(72) Inventor: Scott Finnestad, Red Deer (CA)

(21) Appl. No.: 14/970,522

(22) Filed: Dec. 15, 2015

(51) Int. Cl. B25B 5/14; B25B 7/02

(52) U.S. Cl. CPC B25B 5/147; B25B 7/02

(57) ABSTRACT

In one aspect there is provided a tool attachment for use with a clamping tool having at least one jaw. The tool attachment comprises a semi-cylindrical member having an inner bore along a bore axis and an external groove suitable to capture part of at least one jaw. In another aspect, a tool attachment assembly is provided for use with a clamping tool having two jaws and for use with polished rod having an outside diameter. The tool attachment assembly comprises a pair of tool attachments wherein the each of the inner bores of the pair of tool attachments are each of such dimensions so as to create a total bore having a inner diameter which is smaller than the outer diameter of said polished rod when each one of the pair of tool attachments is attached to the two jaws and when the clamping tool is in a clamped configuration.

### FIELD OF THE INVENTION

The present invention relates to attachments for hand tools. More particularly, the invention relates to attachments for hand tools for use with a polished rod of a pump jack.

### BACKGROUND OF THE INVENTION

The background information discussed below is presented to better illustrate the novelty and usefulness of the present invention. This background information is not admitted prior art.

A stuffing box is an assembly which is used to house a gland seal. It is used to prevent leakage of fluid, such as water or steam, between sliding or turning parts of machine elements. Typically it is used to seal a rotating or reciprocating shaft against a fluid using “packing”. In oil well applications, the pumping action of a beam pump, commonly known as a “pumpjack”, moves a rod string in a reciprocating motion to drive a downhole pump.

For example, an oil well sucker rod pump assembly may include a pump located in the production tubing of an oil producing well, below the level of the liquid in the well. The pump is operated by a string of reciprocating sucker rods that extend through the production tubing from the pump to the surface. The rods are reciprocated by the pumpjack located at the surface. When the fluid being pumped reaches the surface, it is directed into a lateral flow line by a stuffing box mounted on the wellhead. The stuffing box has an opening through which the top sucker rod extends. Seals or packing located in the stuffing box allow the sucker rods to reciprocate in the opening while preventing the pumped fluid from flowing through the top opening. The top sucker rod is usually a special rod, called a “polished rod”, with an outer surface that is machined to a very smooth finish to reduce the friction between the rod and the seals or packing in the stuffing box. Even with a very smooth “polished rod”, the friction generated by the reciprocation of the polished rod, however well machined, will produce heat and contributed to the deterioration of the seals and packing.

The polished rod extends through an axial bore of a stuffing box. The stuffing box contains packing which forms a seal against the polished rod. If the polished rod is not axially aligned with the axial bore of the stuffing box, lateral pressure is exerted upon the stuffing box by the polished rod. This lateral pressure leads to wear and premature failure of both the packing and the polished rod. Regular servicing of the packing and the stuffing box components is therefore often recommended and required.

Most stuffing boxes will therefore require servicing of the packing and any other wearable components, like packing gland inserts or packing retainer bearings. FIG. 1 illustrates an exploded perspective view of a PRIOR ART stuffing box, showing a various components that may need servicing. Typically the top and bottom packing will need regular checking and replacement. Such servicing activity will then also require at least a partial disassembly of the various components and internals of a stuffing box. However, many of these stuffing box components, such as packing glands, packing gland inserts, gland rings, etc. will be positioned around, and captured by, the polished rod. If only the packing is being serviced, then typically the polished rod will remain connected to the head of the pump-jack and a service technician or operator will simply slide such captured stuffing box components upwards along the polished rod, often maintaining them in such a raised position with one hand, while servicing the packing with the other.

Because the outside surface of a polished rod is machined to a very smooth finish, it is undesirable to use traditional clamps or clamping tools (like locking pliers or vice-grips) to clamp below such stuffing box components to maintain them in the raised position. This is because traditional clamping tools have jaws that are ridged or toothed, are made from materials that harder than the polished rod and would significantly scratch, scuff or otherwise damage the smooth machined surface of a polished rod when clamped onto a polished rod. Furthermore, even if a clamping tool could be found with jaws that were sufficiently smooth to safely engage the machined surface of a polished rod, such tool would likely be useless in other, more common, oilfield clamping applications and would then take up valuable space in a service technician's toolbox.

Therefore, what is needed is a tool attachment that will allow a commonly found oil-field clamping tool to safely engage and clamp onto a polished rod.

### BRIEF DESCRIPTION OF THE DRAWINGS

Referring to the drawings, several aspects of the present invention are illustrated by way of example, and not by way of limitation, in detail in the figures, wherein:

FIG. 1 is an exploded perspective view of a PRIOR ART stuffing box, showing a various components that may need servicing;

FIGS. 2a and 2b are perspective views of one embodiment of a tool attachment of the present invention;

FIGS. 3a, 3b and 3c are perspective views of the embodiment of a tool attachment of FIG. 2a, shown attached to a clamping tool, in both an unclamped configuration (FIGS. 3a and 3c) and clamped configuration (FIG. 3b); and

FIG. 4 is a perspective view of the embodiment of a tool attachment of FIG. 2a, shown attached to a clamping tool and in a clamped configuration around a polished rod and supporting a stuffing box component.

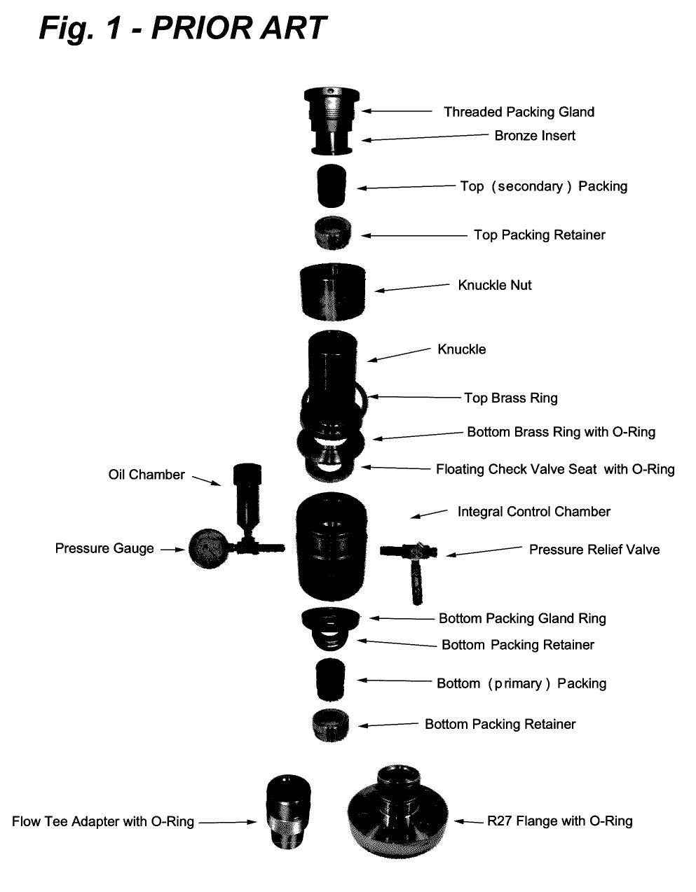

### DETAILED DESCRIPTION OF THE PREFERRED EMBODIMENTS

The following description is of preferred embodiments by way of example only and without limitation to the combination of features necessary for carrying the invention into effect. Reference is to be had to the Figures in which identical reference numbers identify similar components. The drawing figures are not necessarily to scale and certain features are shown in schematic or diagrammatic form in the interest of clarity and conciseness.

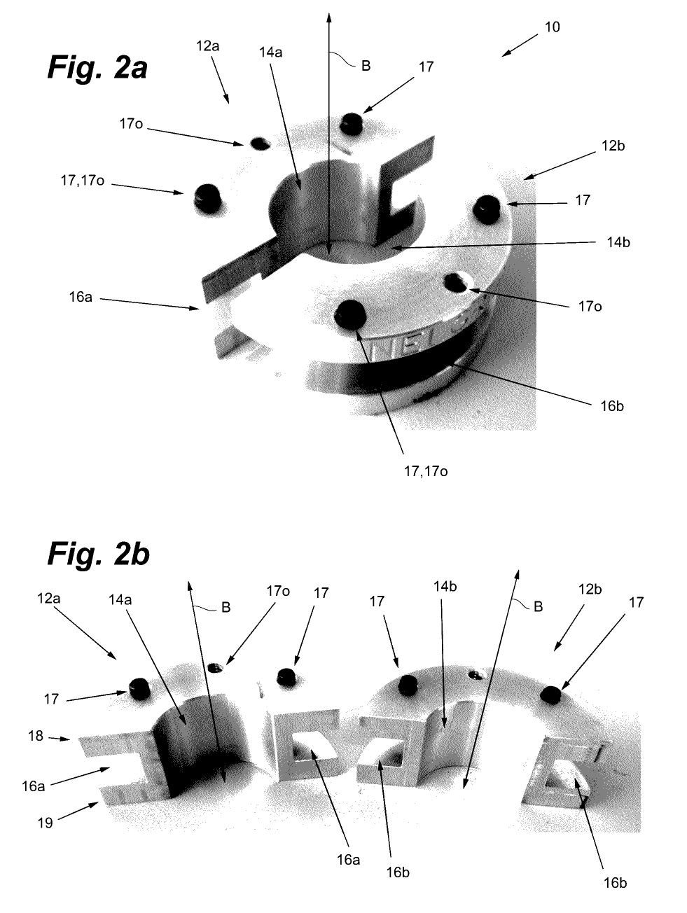

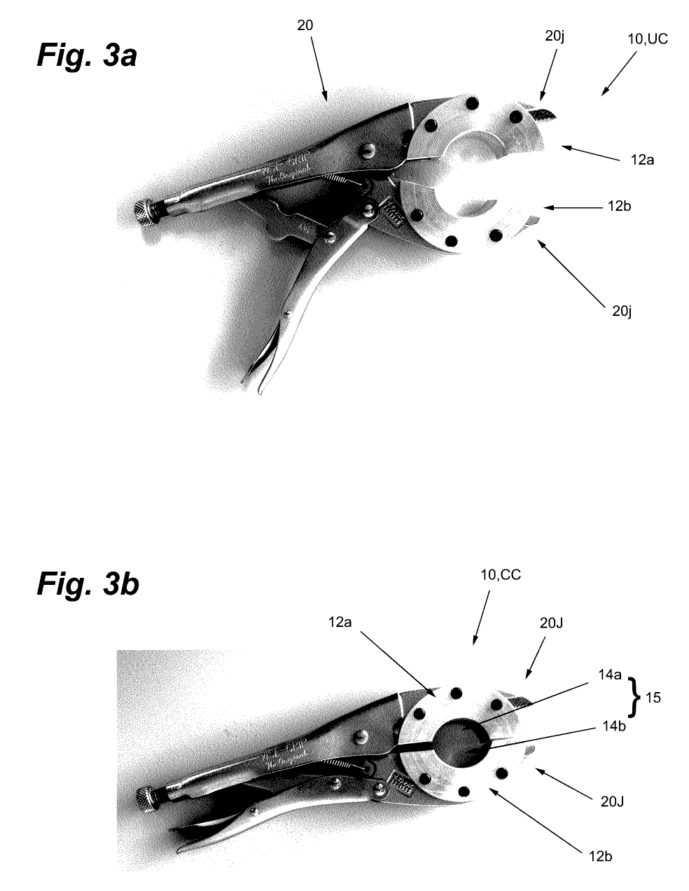

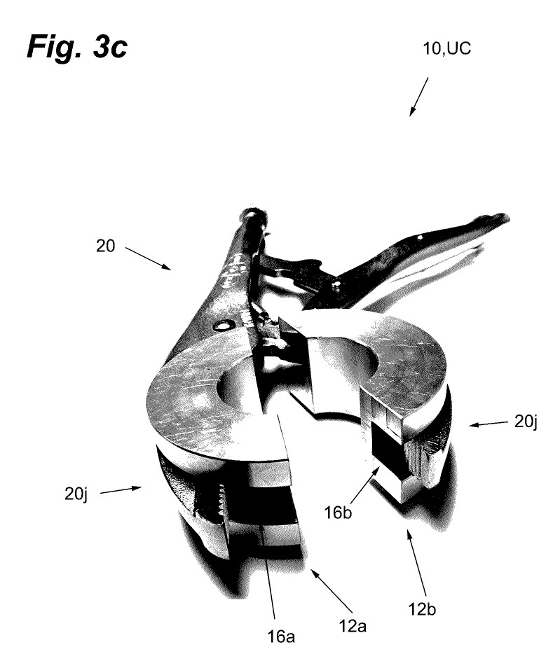

A first embodiment of a tool attachment 10 of the present invention is shown in FIGS. 2a-4. The tool attachment 10 comprises two semi-cylindrical segments 12a, 12b which mate to, or fit around, the jaws 20j of a clamping tool such as pliers 20. Preferably the pliers 20 can be locked into position, using an over-center action. More preferably, the pliers 20 are vise-grips™ brand were the position of the jaws can be easily adjusted. The two semi-cylindrical segments 12a, 12b, when they are attached to the jaws 20j of a clamping tool 20, may be moved or positioned between an unclamped configuration UC (see FIG. 3a) and a clamped configuration CC (see FIG. 3b).

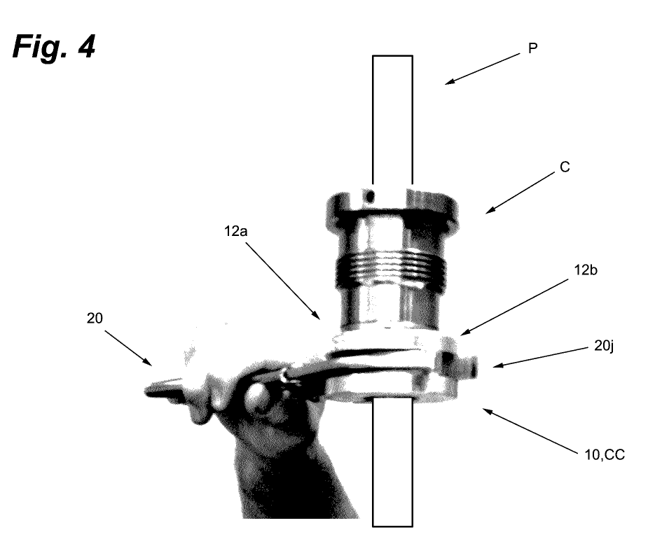

Each semi-cylindrical segment 12a, 12b comprises an inner bore 14a, 14b along a bore axis B. Preferably each inner bore 14a, 14b has a substantially semi-circular cross-section, as is expected of a semi-cylindrical member and as can be seen in FIGS. 2a-4. More preferably, the two inner bores 14a, 14b are each of such dimensions so as to create a total bore 15 having a smaller inner diameter than the outer diameter of a polished rod P when in the clamped configuration CC (see FIG. 3b). More preferably, the surface of inner bores 14a, 14b is a smooth machined surface, without any teeth, ridges or protrusions. Even more preferably, the surface of inner bores 14a, 14b is made of a material that is softer than the material of a polished rod R. A suitable material is aluminum or bronze. Advantageously, when tool attachment 10 is clamped on a polished rod R, and inner bores 14a, 14b engage the outer surface of a polished rod R (e.g. see FIG. 4), there is minimal, if any, chance of scuffing, scratching or otherwise damaging the polished rod R surface. More advantageously, due to the total bore 15 having a smaller diameter than the outside diameter of the polished rod R, and the ability of the clamping tool 20 to lock into position using an over-center action, tool attachment 10 allows such clamping tool 20 so safely clamp onto a polished rod R and support one or more a stuffing box components C without need for continuous human involvement.

To facilitate attachment of the semi-cylindrical segment 12a, 12b to the jaws 20j of a clamping tool 20, each segment 12a, 12b is preferably provided with an external groove 16a, 16b of such dimensions so as to capture all or substantially all of a jaw 20j therein (see FIG. 3c). More preferably, one or more set screws 17 may be provided to maintain the jaws 20j within the external groove 16a, 16b, as can be seen in FIGS. 2a-4. External grooves 16a, 16b may be defined between two semi-circular flanged ends 18, 19 and one or more set screws 17 may be threaded through a threaded opening 17o on such flanged end (e.g. 18), thereby forcing the jaws 20j against the opposing flanged end (e.g. 19); see FIG. 3c.

Advantageously, tool attachment 10 may be easily attached to, and removed from, common oilfield clamping tools, such as locking pliers, thereby avoiding the need for a specialized clamping tool. More advantageously, when not in use, semi-cylindrical segments 12a, 12b will take up minimal space in a toolbox.

Those of ordinary skill in the art will appreciate that various modifications to the invention as described herein will be possible without falling outside the scope of the invention. In the claims, the word “comprising” is used in its inclusive sense and does not exclude other elements being present. The indefinite article “a” before a claim feature does not exclude more than one of the features being present.

The embodiments of the invention in which an exclusive property or privilege is being claimed are defined as follows:

1. A tool attachment for use with a clamping tool having at least one jaw, the tool attachment comprising:
a semi-cylindrical member having an inner bore along a bore axis; and
an external groove suitable to capture part of at least one jaw.

2. The tool attachment of claim 1, further comprising two flanged ends and wherein the external groove is defined by the space between the flanged ends.

3. The tool attachment of claim 2, further comprising at least one set screw threaded through one of said flanged ends and of suitable dimensions to force at least one jaw captured within the external groove against the second flanged end.

4. The tool attachment of claim 1 wherein the inner bore has a substantially semi-circular cross-section.

5. The tool attachment of claim 4 wherein the inner bore has a smooth machined surface.

6. A tool attachment assembly for use with a polished rod having an outside diameter, and with a clamping tool having two jaws and being movable between a clamped configuration and unclamped configuration, the tool attachment assembly comprising:
a pair of tool attachments according to claim 1, each one of said pair of tool attachments being suitable for attachment to one of said two jaws of the clamping tool;
wherein each of the inner bores of said pair of tool attachments are each of such dimensions so as to create a total bore having a smaller inner diameter than the outer diameter of said polished rod when each one of said pair of tool attachments is attached to each of said two jaws and when the clamping tool is in the clamped configuration.
